(19) United States
(12) Patent Application Publication
(10) Pub. No.: US 2025/0221396 A1
(43) Pub. Date: Jul. 10, 2025

(54) PRESENCE INDICATOR MECHANISM FOR RODENT TRAP

(71) Applicant: VMIP, LLC, Bedford, TX (US)

(72) Inventor: Ethan VICKERY, Colleyville, TX (US)

(21) Appl. No.: 19/005,459

(22) Filed: Dec. 30, 2024

Related U.S. Application Data
(60) Provisional application No. 63/617,546, filed on Jan. 4, 2024.

(51) Int. Cl. A01M 23/24; A01M 23/30

(52) U.S. Cl. CPC A01M 23/245; A01M 23/30

(57) ABSTRACT

Pest-management apparatuses and related methods. At least some of the present pest-management apparatuses comprise: an elongated resilient indicator having a first body component configured to be coupled to a capture element of a pest-capture device, the first body component having a proximal end and a connector end; and a second body component configured to be coupled to the first body component, the second body component having a receptacle end and a distal end, the receptacle end configured to be coupled to the connector end of the first body component.

### CROSS-REFERENCE TO RELATED APPLICATIONS

This application claims the benefit of priority of U.S. Provisional Patent Application No. 63/617,546, filed Jan. 4, 2024, which is hereby incorporated by reference in its entirety.

### BACKGROUND

### 1. Field of Invention

The present invention relates generally to pest (e.g., rodent) management and, more particularly, but not by way of limitation, to pest-management apparatuses and methods, including those involve an indicator that a pest-capture device has been actuated.

### 2. Description of Related Art

Examples of pest-management apparatuses are disclosed in U.S. patent Nos.: (1) U.S. Pat. No. 4,026,068; (2) U.S. Pat. No. 4,028,829; (3) U.S. Pat. No. 4,660,320; (4) U.S. Pat. No. 5,953,854; (5) U.S. Pat. No. 6,082,042; and (6) U.S. Pat. No. 6,343,434, and (7) Pub. No. US 2014/0071276. A pest-management apparatus that includes an indicator that a pest-capture device has been actuated is disclosed in US 2018/0325095.

### SUMMARY

This disclosure includes embodiments of pest-management apparatuses, or systems, for detecting pest capture and methods of use. Such embodiments include a secure customizable indicator configured to be coupled (e.g., removably coupled in some such embodiments) to a pest-capture device of the apparatus. Subsequently, a change to the position of such indicator relative to another portion of the apparatus will indicate the occurrence of an event, such as the actuation of a pest-capture device of the apparatus, which actuation may have been triggered by the activity of a pest, such as a rodent, thereby indirectly indicating pest capture under normal circumstances. The present indicators include two body components that are configured in at least some embodiments to be coupled to each other in a manner that precludes their subsequent separation under normal conditions. Further, the body component that will be positioned farthest from the pest-capture device may include a portion configured in a variety of different shapes and/or colors; a user may select a shape and/or color for such component to reflect an association with the kind of pest that is targeted, the kind of bait that is used, and/or the schedule (or timing or time period) by which the apparatus should be checked for an indication of pest capture. In some embodiments, the body component that will be positioned closest to the pest-capture device may include an end configured for removably coupling the component (and, thus, the indicator) to a portion (e.g., a hammer or bar) of the pest-capture device, such as through being hook-shaped (using, e.g., one or more open hook portions); in other embodiments, such body component will have an end configured for non-removably the component (and, thus, the indicator) to a portion (e.g., a hammer or bar) of the pest-capture device, such as through having a locking head (e.g., such as found on structures conventionally referred to as cable or zip ties) through which an opposite end of the component may be threaded and then pulled to tighten the resulting loop around the pest-capture device portion and non-removably couple (e.g., lock) the component thereto. The opposite end of that component may be configured (e.g., preformed or configured manually by a user after locking or non-removably coupling the component to the pest-capture device portion) such that it can then be coupled to the other component of the indicator.

In some configurations of the present apparatuses for detecting pest capture, the apparatus comprises: an indicator having: a first body component configured to be coupled to a capture element of a pest-capture device, the first body component having a proximal end and a connector end; and a second body component configured to be coupled to the first body component, the second body component having a receptacle end and a distal end, the receptacle end configured to be coupled to the connector end of the first body component.

In some of the foregoing configurations of the present apparatuses, the proximal end of the first body component is configured to be removably coupled to the capture element of a pest-capture device. In some such configurations, the proximal end of the first body component is hook-shaped.

In some of the foregoing configurations of the present apparatuses, a surface of the first body component includes a first color and a surface of the second body component includes a second color that is visually distinct from the first color.

In some of the foregoing configurations of the present apparatuses, the first body component includes a first shape and the second body component includes a second shape that is different from the first shape.

In some of the foregoing configurations of the present apparatuses, the first body component includes a first flared flange portion at a proximal portion of the connector end.

In some of the foregoing configurations of the present apparatuses, the second body component includes a second flared flange portion at a distal portion of the receptacle end.

In some of the foregoing configurations of the present apparatuses, the second body component includes a receiving section at a proximal portion of the receptacle end. In some such configurations, the receiving section is bordered by at least one rectangular-shaped opening positioned in a first wall of the proximal portion of the receptacle end. In some such configurations, the at least one rectangular-shaped opening comprises at least two rectangular-shaped openings.

In some of the foregoing configurations of the present apparatuses, the receiving section is bordered by at least one rectangular-shaped opening positioned in a second wall of the proximal portion of the receptacle end. In some such configurations, the receiving section is also bordered by a notch that begins at a proximal edge of the second wall of the proximal portion of the receptacle end.

In some of the foregoing configurations of the present apparatuses, a rectangular-shaped opening of the at least one rectangular-shaped opening positioned in the first wall is longitudinally offset from a rectangular-shaped opening of the at least one rectangular-shaped opening positioned in the second wall.

In some of the foregoing configurations of the present apparatuses, a rectangular-shaped opening of the at least one rectangular-shaped opening positioned in the first wall is oriented parallel to a rectangular-shaped opening of the at least one rectangular-shaped opening positioned in the second wall.

In some of the foregoing configurations of the present apparatuses, an inner surface of the first wall includes one or more first-wall teeth. In some such configurations, the inner surface includes two sections of one or more first-wall teeth, the two sections separated from each other at least in part by a rectangular-shaped opening of the at least one rectangular-shaped opening positioned in the first wall.

In some of the foregoing configurations of the present apparatuses, an inner surface of the second wall includes one or more second-wall teeth. In some such configurations, the inner surface of the second wall includes two sections of one or more second-wall teeth, the two sections of one or more second-wall teeth separated from each other at least in part by a rectangular-shaped opening of the at least one rectangular-shaped opening positioned in the second wall.

In some of the foregoing configurations of the present apparatuses, first and second sides of a distal portion of the connector end of the first body component each include at least one smooth section and at least one section having one or more connector-end teeth, and wherein the connector end and the receptacle end are configured such that the when the first body component is coupled to the second body component: a smooth section of the at least one smooth section of the first side fits into a rectangularly-shaped opening of the at least one rectangularly-shaped opening positioned in the first wall; a smooth section of the at least one smooth section of the second side fits into a rectangularly-shaped opening of the at least one rectangularly-shaped opening positioned in the second wall; at least one of the one or more connector-end teeth of the first side interferes with one of the one or more first-wall teeth to resist separation of the first body component from the second body component in response to pulling the first and second body components in opposite directions; and at least one of the one or more connector-end teeth of the second side interferes with one of the one or more second-wall teeth to resist separation of the first body component from the second body component in response to pulling the first and second body components in opposite directions.

In some of the foregoing configurations of the present apparatuses, the proximal end of the first body component comprises a first locking head.

In some of the foregoing configurations of the present apparatuses, a first and/or a second side of the first body component includes one or more teeth.

In some of the foregoing configurations of the present apparatuses, the connector end of the first body component is configured to be inserted through an opening in the first locking head of the first body component.

In some of the foregoing configurations of the present apparatuses, the first body component includes a strap portion extending from the first locking head. In some such configurations, the connector end of the first body component includes a distal portion of the strap portion.

In some of the foregoing configurations of the present apparatuses, the receptacle end of the second body component comprises a second locking head, and wherein the connector end and the receptacle end are configured such that the when the first body component is coupled to the second body component: at least one of the one or more teeth of the first and/or second side of the first body component interferes with the second locking head of the receptacle end of the second body component to resist separation of the first body component from the second body component in response to pulling the first and second body components in opposite directions.

In some of the foregoing configurations of the present apparatuses, the indicator has a long dimension and a thickness and a width, the thickness and the width each taken perpendicularly to the long dimension; and the width is at least two times the thickness.

In some of the foregoing configurations of the present apparatuses, at least the first body component and/or the second body component of the indicator includes a reflective surface.

Some configurations of the present systems comprise one of the foregoing configurations of the present apparatuses for detecting pest capture, and a pest management apparatus; where the pest management apparatus has: a base having a floor defining a first opening and a sidewall that defines an external perimeter of the base; a lid coupled to the base such that the lid is movable relative to the base between an open position and a closed position in which the lid and the base cooperate to define a chamber; a pest-capture device disposable within the chamber, the pest-capture device having a body defining a second opening and a capture element that is movable relative to the body between a set position and a capture position; and a fastener configured to extend through the first opening and the second opening to couple the pest-capture device to the base. In some such configurations, the pest management apparatus is configured such that movement of the capture element from the capture position to the set position moves the indicator from a first position to a second position.

In some of the foregoing configurations of the present systems, the proximal end of the first body component of the indicator is configured to be coupled to the capture element of the pest-capture device such that: the indicator extends through and is movable relative to the pest management apparatus; if the lid is in the closed position and the capture element is in the set position, the first body component of the indicator is visible from outside of the chamber and the distal end of the second body component of the indicator extends higher the lid and laterally beyond the external perimeter of the base; and if the lid is in the closed position and the capture element is in the capture position, at least a majority of the first body component of the indicator is not visible from outside of the chamber; wherein the second end of the fastener is moveable between an engaged position and a released position.

In some of the foregoing configurations of the present systems, when the lid is in the closed position and the capture element is in the capture position, at least a majority of the second body component is visible from outside of the chamber.

In some configurations of the present pest capture devices, the device comprises: a lower jaw member having a floor defining an opening and a sidewall defining an external perimeter of the lower jaw member; a capture element comprising an upper jaw member configured to be coupled to the lower jaw member such that the upper jaw member is movable relative to the lower jaw member between a set position and a capture position, the upper jaw member having an upper wall with a surface area which is greater than 30% of a surface area of the floor of the lower jaw member, the upper jaw member configured to be coupled to an indicator for detecting pest capture and/or a cable tie; a trigger plate mounted to the lower jaw member such that the trigger plate is disposed between the lower jaw member and the upper jaw member; and a catch mechanism which restrains the upper jaw member in the set position until the trigger plate is actuated.

In some of the foregoing configurations of the present pest capture devices, at least a front portion of the sidewall of the lower jaw member has protruding teeth.

In some of the foregoing configurations of the present pest capture devices, the upper jaw member comprises a sidewall that defines an external perimeter of the upper jaw member.

In some of the foregoing configurations of the present pest capture devices, at least a front portion of the sidewall of the upper jaw member has protruding teeth. In some such configurations, when in the capture position the protruding teeth of the upper jaw member contact the floor of the lower jaw member such that the protruding teeth of the upper jaw member are spaced inwardly from the protruding teeth of the lower jaw member.

In some of the foregoing configurations of the present pest capture devices, the upper wall of the upper jaw member defines an opening comprising a bar such that the bar is disposed within the opening. In some such configurations, the opening is positioned at the center of the upper jaw member. In some such configurations, the opening is positioned at a front edge of the upper wall of the upper jaw member.

In some of the foregoing configurations of the present pest capture devices, the indicator of one of the foregoing configurations of the present apparatuses for detecting pest capture is coupled to the bar of the upper jaw member such that movement of the upper jaw member from the capture position to the set position moves the indicator from a first position to a second position.

In some configurations of the present systems, the system comprises: one of the foregoing configurations of the present apparatuses for detecting pest capture; one of the foregoing configurations of the present pest capture devices in which the upper jaw member having an upper wall with a surface area which is greater than 30% of a surface area of the floor of the lower jaw member; and a pest management apparatus having: a base having a floor and a sidewall that defines an external perimeter of the base, the floor and sidewall defining an interior region; a lid coupled to the base such that the lid is movable relative to the base between an open position and a closed position in which the lid and the base cooperate to define a chamber, the lid defining a first opening; where the pest capture device is disposed in the interior region of the base with the lower jaw member of the pest capture device coupled to the floor of the base; and where the indicator is coupled to the upper jaw member of the pest capture device and extends through the first opening of the lid. In some such configurations, the base defines a second opening through the floor; and the system further comprises: a fastener configured to extend through the second opening and the opening of the lower jaw member to couple the pest-capture device to the base.

In some of the foregoing configurations of the present systems, the pest management apparatus is configured such that movement of the upper jaw member from the capture position to the set position moves the indicator from a first position to a second position.

In some of the foregoing configurations of the present systems, the proximal end of the first body component of the indicator is configured to be coupled to the upper jaw member of the pest-capture device such that: the indicator extends through and is movable relative to the pest management apparatus; if the lid is in the closed position and the upper jaw member is in the set position, the first body component of the indicator is visible from outside of the chamber and the distal end of the second body component of the indicator extends higher than the lid and laterally beyond the external perimeter of the base; and if the lid is in the closed position and the upper jaw member is in the capture position, at least a majority of the first body component of the indicator is not visible from outside of the chamber; and wherein the fastener is moveable between an engaged position and a released position.

In some of the foregoing configurations of the present systems, when the lid is in the closed position and the capture element is in the capture position, at least a majority of the second body component of the indicator is visible from outside of the chamber.

The term “coupled” is defined as connected, although not necessarily directly. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” may be substituted with “within [a percentage] of” what is specified, where the percentage includes 0.1, 1, 5, and 10 percent.

Further, an apparatus, device, or a component of either that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment(s) depicted in the figures.

FIGS. 1 and 2 are front and rear perspective views, respectively, of one embodiment of an indicator of the present pest-management apparatuses for detecting pest capture

FIGS. 3A and 3B are enlarged detail views of the coupled body components of the indicator shown in FIGS. 1 and 2.

FIG. 4 is a perspective view of the indicator shown in FIGS. 1 and 2 in which the first body component and the second body component are not coupled to each other.

FIGS. 5A and 5B are an enlarged detail views of the connector end of the first body component shown in FIGS. 1 and 2.

FIGS. 6A and 6B are enlarged detail views of the receptacle end of the second body component shown in FIGS. 1 and 2.

FIG. 7 is a perspective view of a second embodiment of the present apparatuses with the lid removed to enable viewing of the interior.

FIG. 8 is a perspective view of the apparatus shown in FIG. 7 with the lid in the closed position and the indicator in the first position.

FIG. 9 is a side view of the apparatus of FIG. 8.

FIG. 10 is a perspective view of the apparatus shown in FIG. 8 but with the indicator in the second position.

FIG. 11 is a bottom view of the apparatus shown in FIG. 8.

FIG. 12 is a perspective view of the indicator coupled to a pest capture device of the second embodiment.

FIG. 13 is a perspective view of a third embodiment of the present apparatuses with the lid removed to enable viewing of the interior, the third embodiment differing from the second embodiment only with respect to configuration of the pest capture device.

FIGS. 14A and 14B are front and perspective views of the pest capture device of the third embodiment in the set and capture positions, respectively.

FIGS. 15A and 15B are front and perspective views of the indicator coupled to the pest capture device of a fourth embodiment of the present apparatuses in the set and capture positions, respectively, the fourth embodiment differing from the third embodiment only with respect to the configuration of the upper wall of the upper jaw member of the pest capture device.

FIG. 16 is a front perspective view of the pest capture device of FIG. 15B without the indicator.

### DETAILED DESCRIPTION OF ILLUSTRATIVE EMBODIMENTS

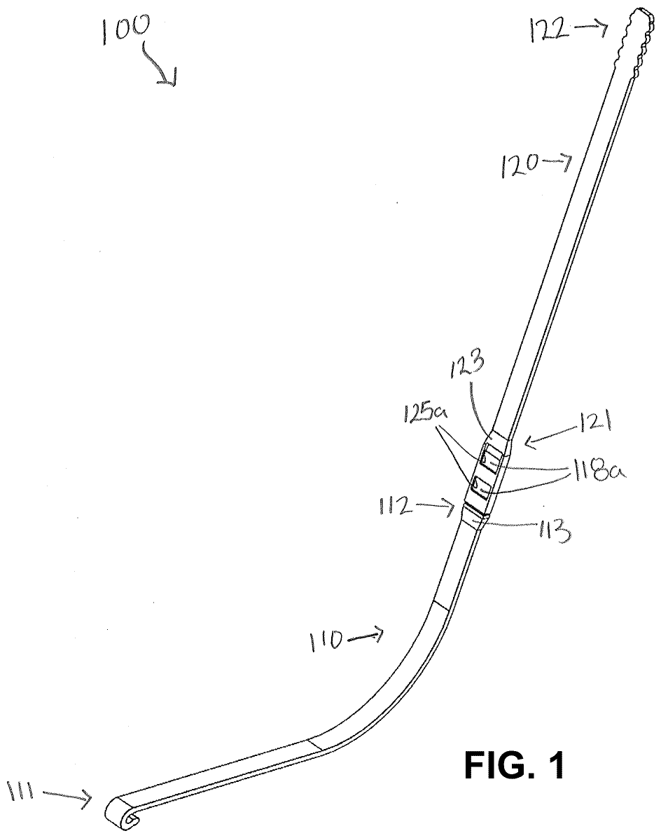

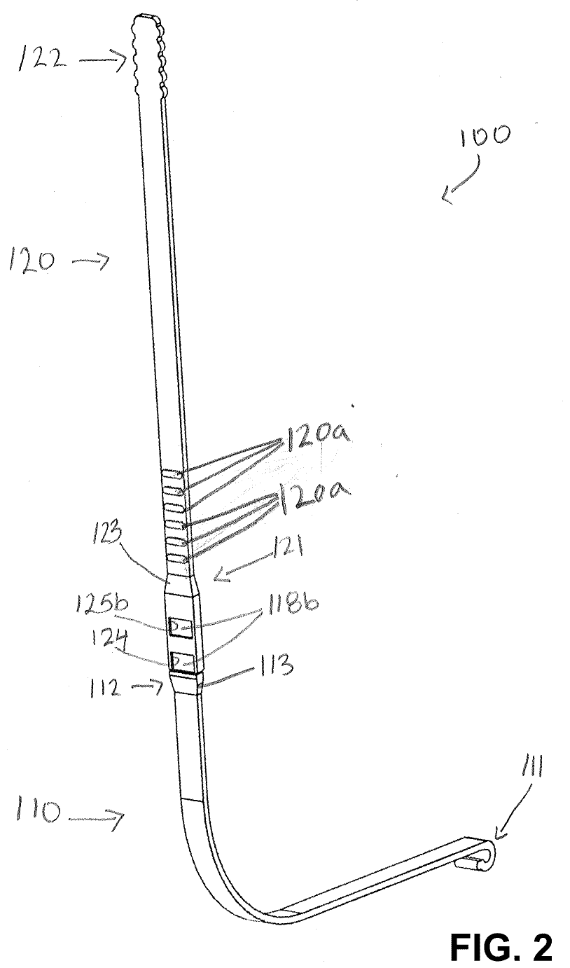

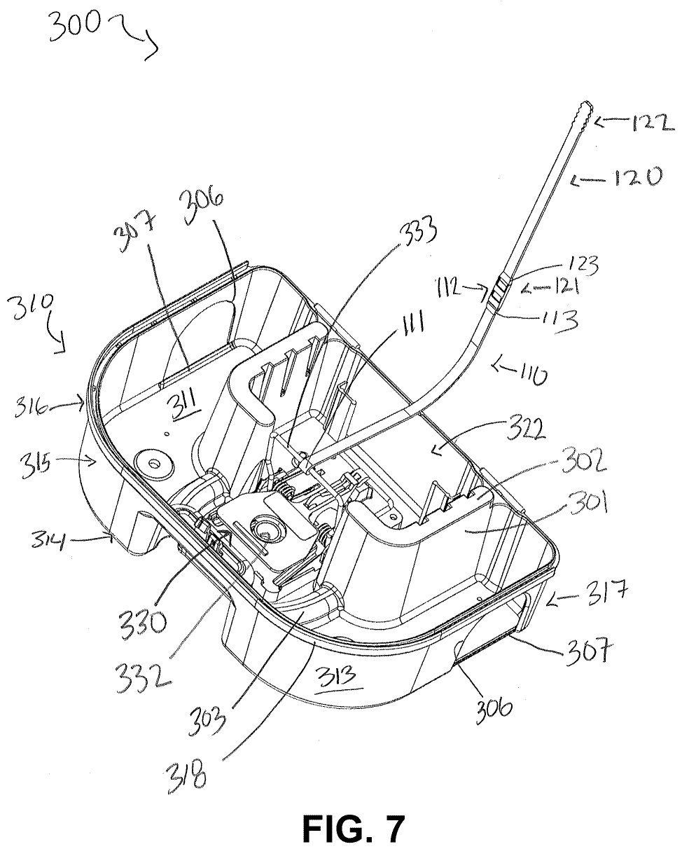

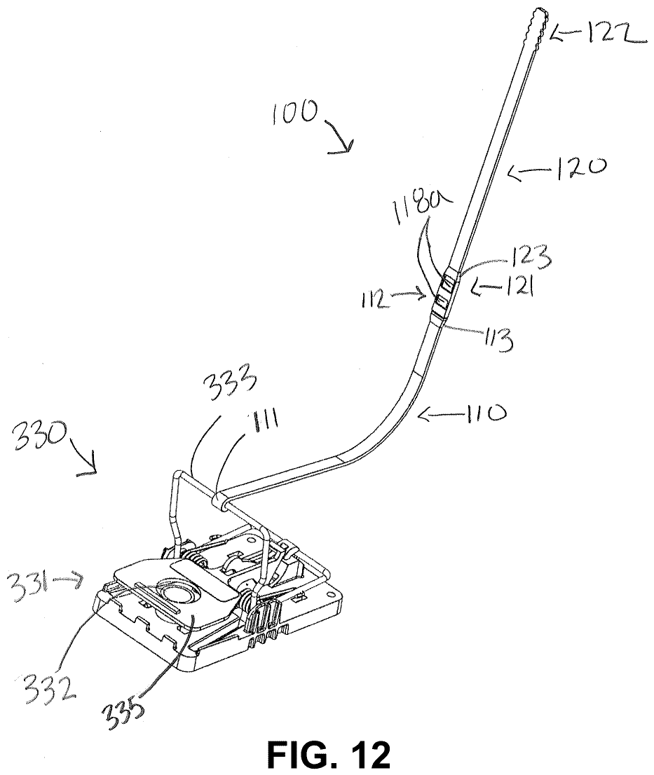

Referring now to the drawings, FIGS. 1 and 2 are perspective views of one embodiment of an indicator of the present pest management apparatuses for detecting pest capture. As will be described in more detail below, in the embodiment shown, indicator 100 includes first body component 110 configured to be coupled to a capture element of a pest capture device (such as pest capture device 330, shown in FIGS. 7 and 12), the first body component having proximal end 111 (which can be coupled to such a device) and connector end 112; and second body component 120, the second body component having receptacle end 121 and distal end 122, the receptacle end configured to be coupled to (and is coupled to, in the depicted embodiment) the connector end of first body component 110.

As reflected in these figures and others (such as FIG. 2), the surface of second body component 120 includes raised bumps 120a to assist in gripping second body component 120 when coupling/decoupling second body component 120 and first body component 110.

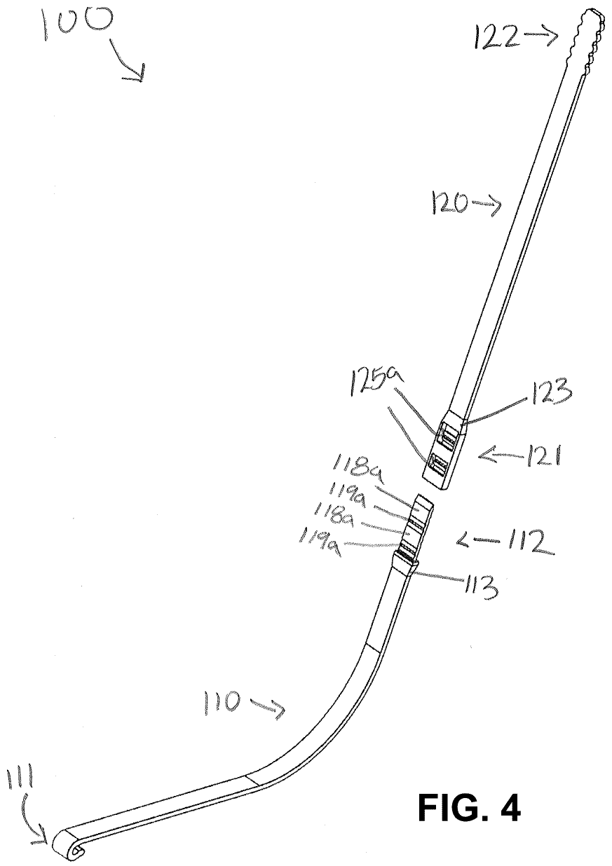

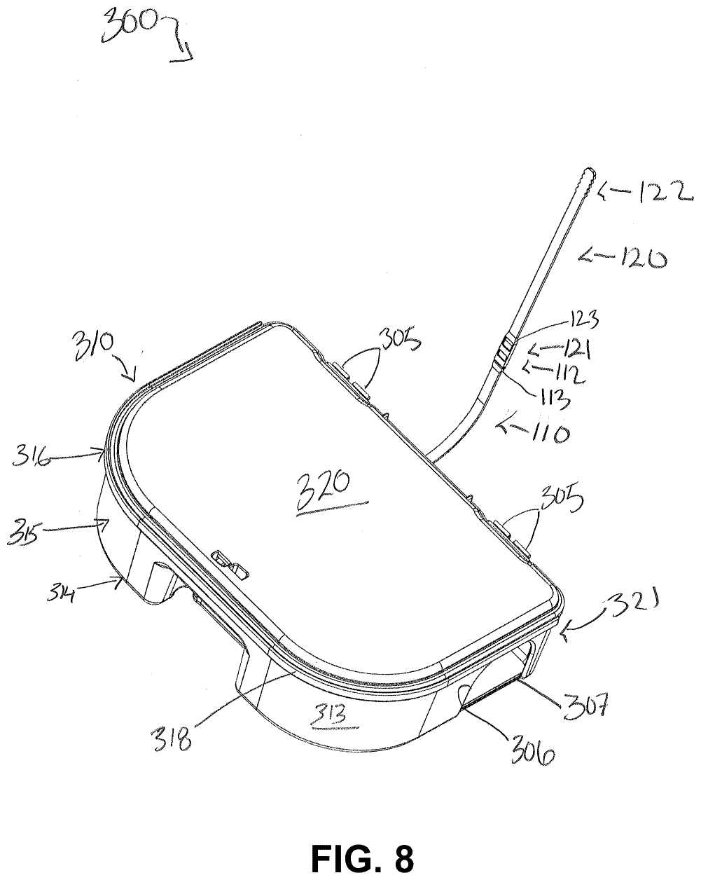

As reflected in these figures and others (such as FIGS. 4 and 8), proximal end 111 of first body component 110 is configured to be removably coupled to capture element 333 of a pest capture device. As reflected in these figures and others, proximal end 111 of first body component 110 may be so configured by being hooked shaped. In other embodiments, proximal end 110 may be so configured by comprising a first locking head.

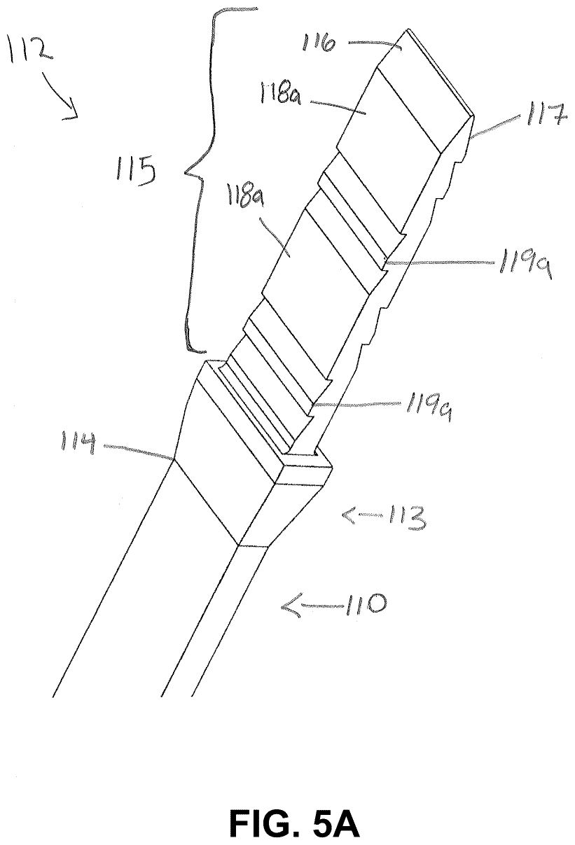

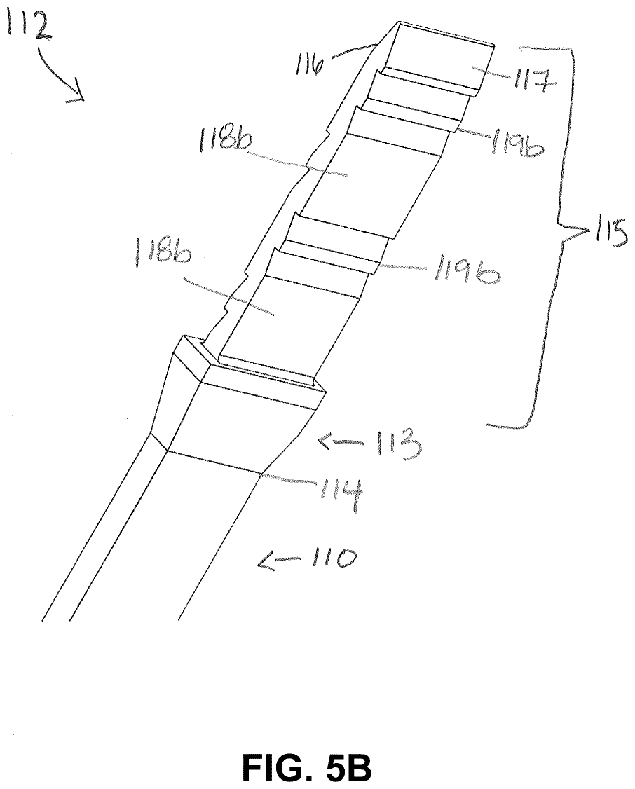

In the depicted embodiment, and as shown in FIGS. 5A and 5B, first body component 110 includes first flared flange portion 113 at proximal portion 114 of connector end 112. More particularly, in this embodiment, distal portion 115 of connector end 112 of first body component 110 has first 116 and second 117 sides each having: one or more smooth sections 118a and 118b, and one or more sections with connector end teeth 119a and 119b, respectively.

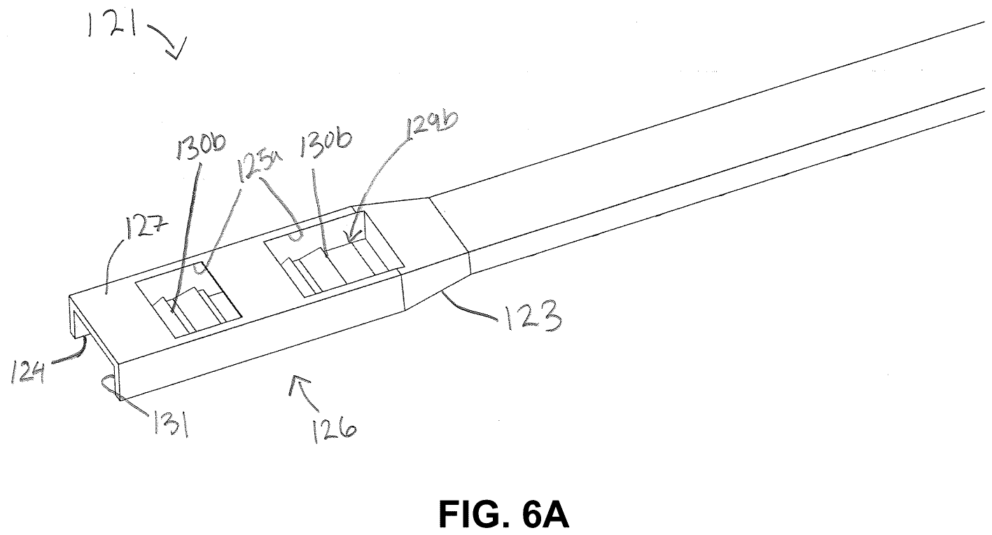

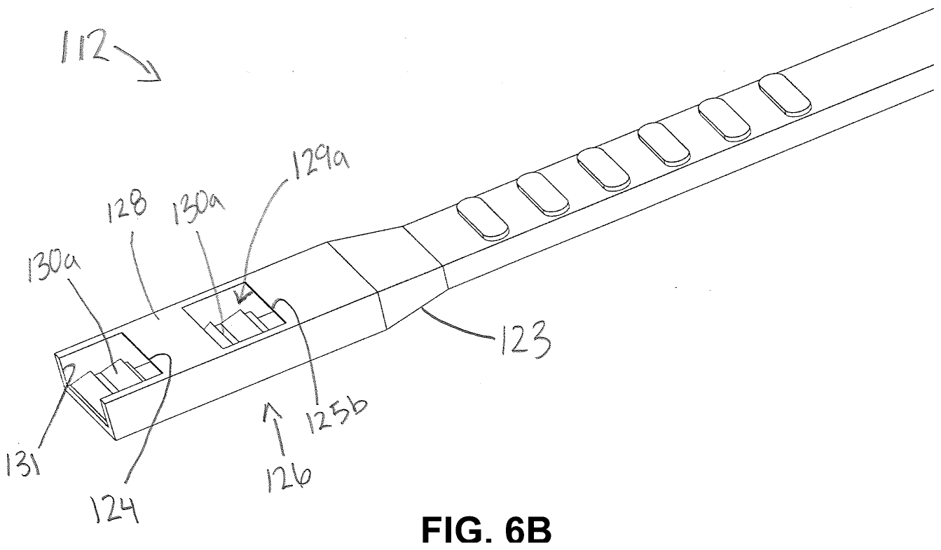

In the depicted embodiment, and as reflected in, e.g., FIGS. 6A and 6B, second body component 120 includes second flared flange portion 123 at a distal portion of receptacle end 121 and receiving section 131 at proximal portion 126 of receptacle end 121. Receiving section 131 is configured to receive distal portion 115 of first body component 110 and is bordered by at least one rectangular-shaped opening 125a positioned in first wall 127 of proximal portion 126 of receptacle end 121. The at least one rectangular-shaped opening 125a positioned in first wall 127 of proximal portion 126 of receptacle end 121 may comprise at least two rectangular shaped openings 125a.

In the depicted embodiment, receiving section 131 is also bordered by at least one rectangular shaped opening 125b positioned in second wall 128 of the proximal portion of receptacle end 121. More particularly in this embodiment, rectangular-shaped opening 125a positioned in first wall 127 is longitudinally offset from and oriented parallel rectangular-shaped opening 125b positioned in second wall 128.

In the depicted embodiment, receiving section 131 is also bordered by notch 124 that begins at a proximal edge of second wall 128 of the proximal portion of the receptacle end 121.

In the depicted embodiment, inner surface 129a of first wall 127 includes one or more first wall teeth 130a. More particularly in this embodiment, inner surface 129a includes two sections of one or more first wall teeth 130a, the two sections separated from each other at least in part by rectangular-shaped opening 125a positioned in first wall 127.

In the depicted embodiment, inner surface 129b of second wall 128 includes one or more second wall teeth 130b. More particularly in this embodiment, inner surface 129b includes two sections of one or more second wall teeth 130b, the two sections of second wall teeth 130b separated from each other at least in part by rectangular-shaped opening 125b positioned in second wall 128.

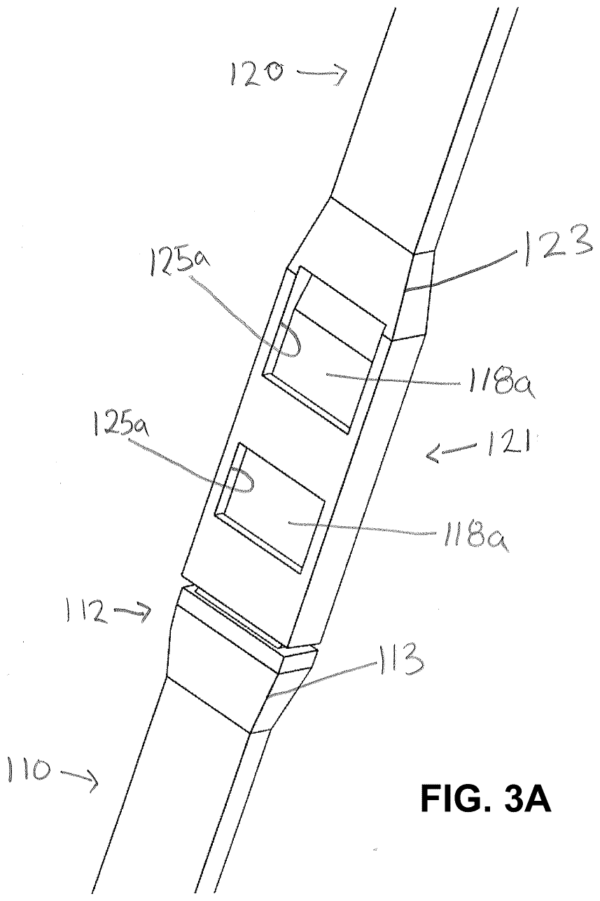

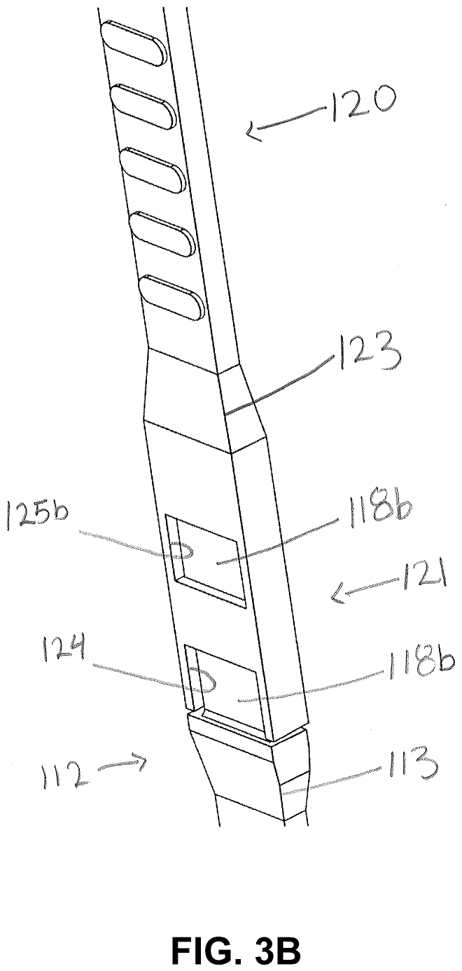

In the depicted embodiment, and as shown in FIGS. 3A and 3B, when first body component 110 is coupled to second body component 120: a smooth section 118a of first side 116 of connector end 112 fits into rectangularly-shaped opening 125a positioned in first wall 127 of receptacle end 121; while smooth section 118b of second side 117 of connector end 112 fits into rectangularly-shaped opening 125b positioned in second wall 128 of receptacle end 121. More particularly in this embodiment, at least one of the one or more connector-end teeth 119a of first side 116 of connector end 112 interferes with one of the one or more first wall teeth 130a of receptacle end 121 to resist separation of first body component 110 from second body component 120 in response to pulling the first and second body components in opposite directions; and at least one of the one or more connector-end teeth 119b of second side 117 interferes with one of the one or more second-wall teeth 130b of receptacle end 121 to resist separation of first body component 110 from second body component 120 in response to pulling the first and second body components in opposite directions.

As shown in FIG. 7, some embodiments of the present pest-management apparatuses for detecting pest capture comprise indicator 100 and (e.g., coupled to) a pest management apparatus 300 having base 310 with floor 311 defining first opening 312 and sidewall 313 that defines an external perimeter of the base 311.

In some embodiments, apparatus 300 includes lid 320 configured to be coupled to base 310 such that lid 320 is movable (e.g., including removable) relative to base 310 between an open position (FIG. 7) and a closed position (FIG. 8) in which base 310 and lid 320 cooperate to define interior chamber 321. Each of base 310 and lid 320 may be separately molded from a suitable (e.g., plastic) material. In other embodiments, the base (e.g., 310) and lid (e.g., 320) may be integrally formed from a suitable (e.g., plastic) material.

Apparatus 300 includes pest capture device 330 disposable within chamber 321. More particularly in this embodiment, pest capture device 330 has body 331 defining second opening 332, trigger 334, and capture element 333 that is moveable relative to body 331 between a set position and a capture position.

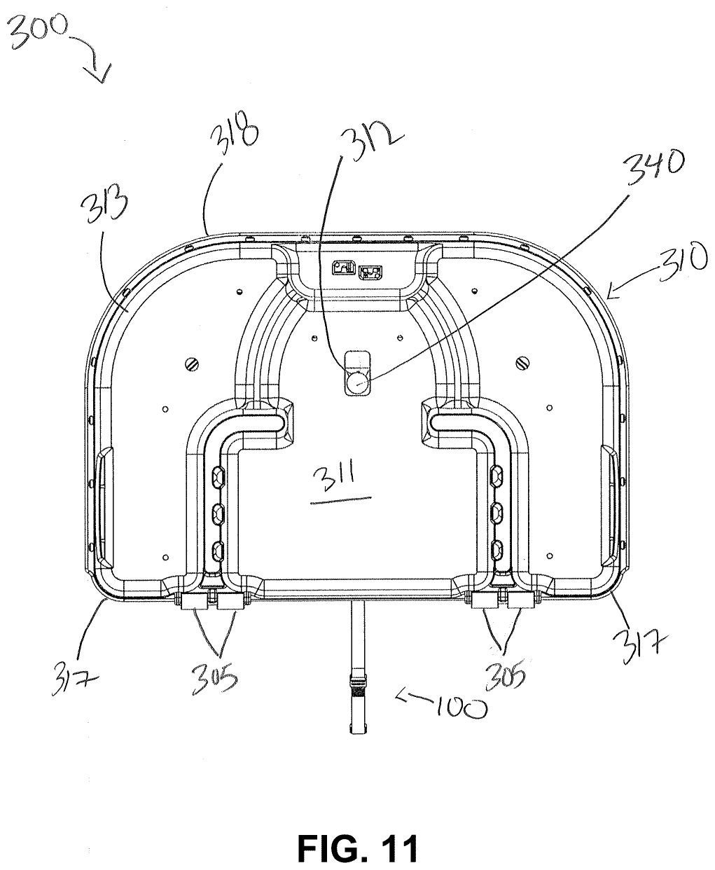

In the second embodiment, and as shown in FIG. 11, apparatus 300 includes fastener 340 configured to extend through first opening 312 to couple pest-capture device 330 to base 310, fastener 340 configured to engage body 331.

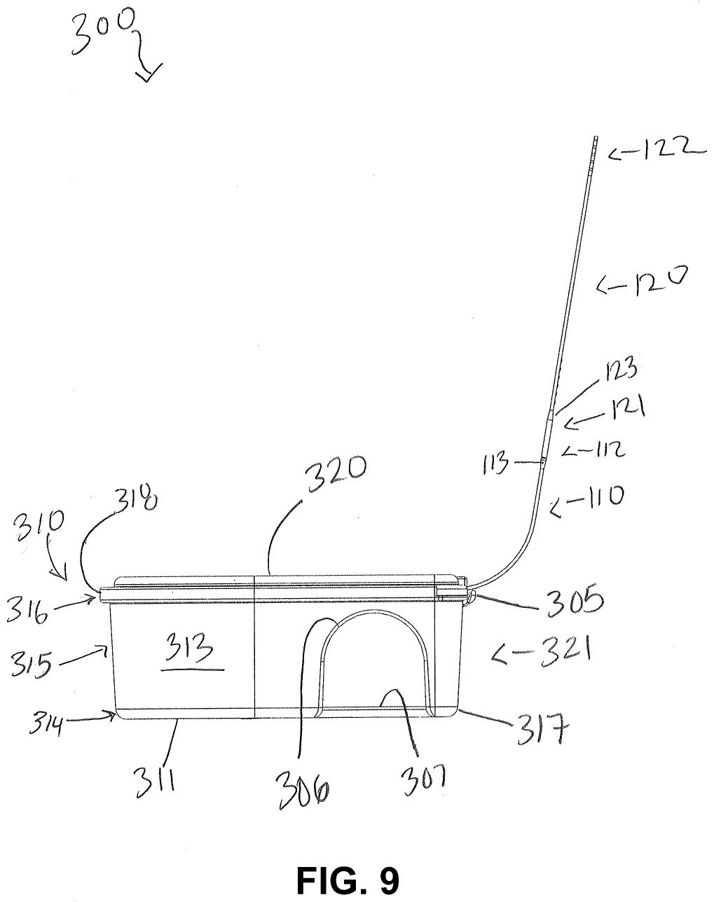

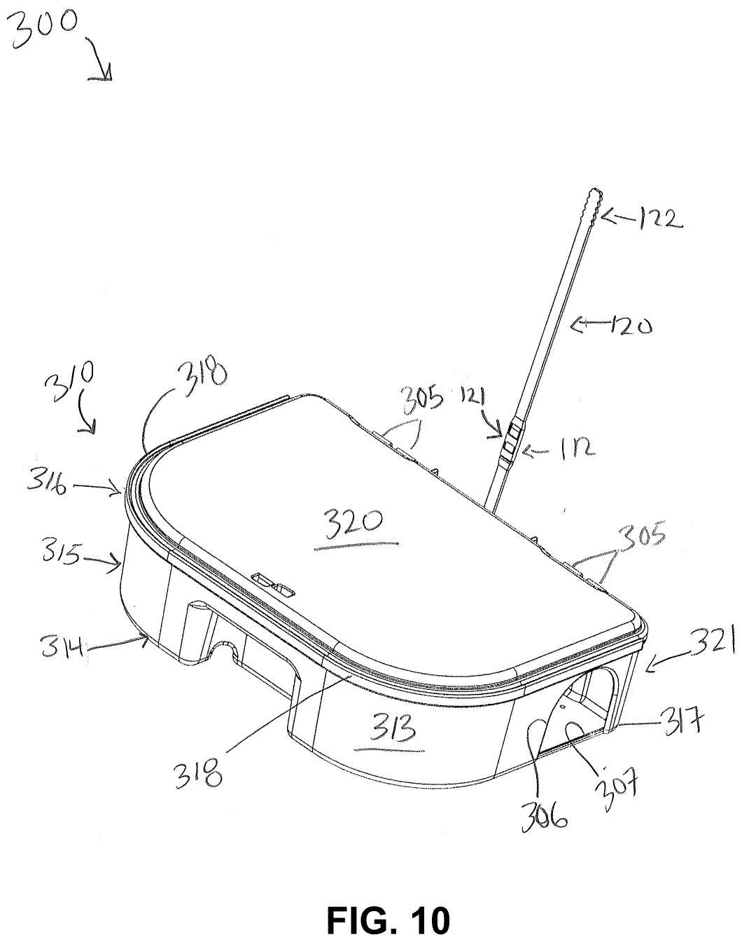

In the second embodiment, and as shown in FIGS. 9 and 10, sidewall 313 includes lower portion 314, upper portion 316, and middle portion 315 disposed between upper portion 316 and lower portion 315. In this embodiment, sidewall 313 of base 310 also includes corner portions 317 (FIG. 7) across which sidewall 313 may change direction. Corner portions 317 may include any appropriate shape (e.g., to guide a rodent exterior to base 310 toward opening(s) 312). For example, one or more corner portions 317 may be curved or flat. In some embodiments, at least one corner portion 317 (e.g., two corner portions closest to lid 320, in the embodiment shown, for example, in FIG. 7) includes a first radius of curvature and at least one other corner portion (e.g., two corner portions opposite the lid, in the embodiment shown, for example, in FIG. 7) includes a second radius of curvature greater than the first radius of curvature. For example, the second radius of curvature may be more than any of, or between any of two of: 50, 60, 75, 90, or 100 percent of the first radius of curvature. In the embodiment shown, middle portion 315 of sidewall 313 between corner portions 317 is substantially planar. Nevertheless, sidewalls (e.g., 313) of the present bases (e.g., 310) may comprise any suitable shape, such as, for example, including corner portion(s) (e.g., 317) that are sharp (e.g., so as to define an edge), and/or the like, including a middle portion (e.g., 315) that is curved (e.g., concave or convex), and/or the like. In this embodiment, base 310 includes floor 311 from which sidewall 313 extends; however, in other embodiments, a floor, or a portion thereof, of a base (e.g., 310) may be omitted, and, in such embodiments, a surface upon which the base is disposed may function, at least in part, as the floor.

In the second embodiment, sidewall 313 may be configured to discourage a rodent at or near the sidewall from climbing on top of lid 320 when the lid is in the closed position. For example, in the embodiment shown, middle portion 315, or a portion thereof, of sidewall 313 is disposed at a non-perpendicular angle relative to floor 311, such that, for example, a corresponding upper portion 316 of the sidewall extends laterally beyond a corresponding lower portion 314 of the sidewall (e.g., base 310 may taper in a transverse dimension across the middle portion from the corresponding upper portion to the corresponding lower portion). More particularly, in this embodiment, upper portion 316, or a portion thereof, extends laterally beyond a corresponding lower portion 314 by a distance that is at least 5 percent (e.g., 10, 15, 20, 25, 30, or more percent) of a height of the sidewall. For further example, in the depicted embodiment, upper portion 316 of sidewall 313 includes lip 318 that extends laterally in a direction away from chamber 321.

In the second embodiment shown, base 310 includes one or more interior walls 301 (e.g., two interior walls 301, as shown in the embodiment, for example, in FIG. 7), each extending substantially vertically from floor 311 and toward a top of base 310. In the depicted embodiment, at least one of interior wall(s) 301 is configured to prevent a rodent from climbing over the interior wall when lid 320 is in the closed position. For example, in the embodiment shown, at least one of interior wall(s) 301 includes upper surface 302 configured to contact lid 320 when the lid is in the closed position. In this embodiment, at least one of interior wall(s) 301 at least partially extends above upper portion 316 of sidewall 313 such that upper surface 302 is disposed at least partially above the sidewall, as shown, for example, in FIG. 7.

In the second embodiment, base 310 includes one or more interior protrusions 303, such as ridges (e.g., two protrusions 303, as shown) that each extend from floor 311 and toward a top of base 310. When lid 320 is in the closed position, interior wall(s) 301 and protrusion(s) 303 may cooperate with the lid to define a bait subchamber 322 within chamber 321. In the embodiment shown, protrusion(s) 303 are located such that, when lid 320 is in the closed position, at least a portion of chamber 321 may only be accessed by passing over at least one of the protrusion(s) 303. For example, in this embodiment, one or more protrusions 303 each extend between sidewall 313 and an interior wall 301 such that, for example, when lid 320 is in the closed position, access to bait subchamber 322 is only possible by passing over one of the protrusion(s) 303. In the depicted embodiment, one or more protrusions 303 each include a height (e.g., extending in a direction perpendicular to floor 311), which is selected to allow a rodent to climb over the protrusion when lid 320 is in the closed position, but to inhibit liquids from reaching at least a portion of chamber 321, such as, for example, bait subchamber 322. The height of one or more protrusions 303 may be less than (e.g., such as 40, 50, 75, 80, or 90 percent of) a height of interior walls 301.

In the second embodiment shown, lid 320 includes one or more ridges 304 (e.g., two ridges 304, as shown), each extending from inner surface 323 of lid 320. In this embodiment, when lid 320 is in the closed position, each ridge 304 is configured to contact a respective interior wall 301 (e.g., surface 302) of base 310, such that, for example, the ridge(s) and interior wall(s) cooperate to define bait subchamber 322. In at least this way, when lid 320 is in the closed position, inner surface 323, or a portion thereof, of the lid may be spaced apart from base 310 by one or more ridges 304, thereby providing for an increased volume within chamber 321. In some embodiments such ridge(s) may be configured to increase a stiffness of a lid.

In the second embodiment, lid 320 is configured to be coupled to base 310 via one or more hinges 305 (e.g., two hinges 305, as shown). For example, in the embodiment shown, each hinge 305 includes a hinge and one or more hooks, where the hinge pin is configured to be pivotally received within an interior channel of each of the hook(s). In this embodiment, for each hinge 305, the interior channel of each of hook(s) is open in cross-section, such that, for example, the hinge may be assembled or disassembled by pressing hinge pin (e.g., laterally) into or out of, respectively, the interior channel. In the depicted embodiment, for at least one of hinge(s) 305, hook(s) are a component of (e.g., are coupled to or integrally formed with) lid 320 and hinge pin is a component of (e.g., is coupled to or integrally formed with) base 310. Accordingly, in the embodiment shown, base 310 may include one or more openings, each configured to receive a respective one of hook(s) as lid 320 is pivoted relative to the base 310 (e.g., to prevent interference between the hook(s) and the base). In other embodiments, hook(s) of a hinge may be a component of a base and a hinge pin of the hinge may be a component of a lid. In yet other embodiments, a lid may be integrally formed with a base, such that, for example, hinge(s) comprise living hinges. In yet other embodiments, a lid may be coupled to a base in any suitable fashion, such as, for example, being slidably coupled to the base, removably (e.g., detachably) coupled to the base (e.g., without hinges), and/or the like.

In the second embodiment, base 310 includes at least one opening 306 (e.g., two openings 306, as shown), each configured to permit a rodent exterior to the apparatus to enter chamber 321. In the depicted embodiment, a lower-most portion 307 of at least one of openings(s) 306 is spaced above a bottom of base 310 (e.g., by 0.2, 0.4, 0.6, 0.8, 1.0, 1.2, 1.4, 1.6, 1.8, 2.0, or more centimeters (cm)), which may inhibit liquids from entering chamber 321 through the opening. In the embodiment shown, each opening 306 is defined by base 310 alone (e.g., the entire outer perimeter of the opening is defined by the base); however, in other embodiments, one or more openings (e.g., 306) may be defined by a base (e.g., 310) and a lid (e.g., 320), when the lid is in a closed position, and/or by the lid alone.

In the second embodiment, base 310 includes a pest-capture device 330 (FIG. 7), which is disposable within chamber 321 (e.g., bait subchamber 322) and is configured to prevent a pest that is captured by the pest-capture device from exiting the chamber. In the depicted embodiment, pest-capture device 330 comprises a snap trap, having a body 331 and a capture element 333 (e.g., a hammer or bar), which is movable relative to the body between a set position (e.g., as shown, for example, in FIG. 12) and a capture position in which the capture element is closer to the body. In other embodiments, a capture element (e.g., 333) may include a jaw. In the embodiment shown, capture element 333 may be biased toward the capture position via a biasing member, such as, for example, a spring. In this embodiment, pest-capture device 330 includes a releasable catch configured to retain capture element 333 in the set position and a trigger coupled to the catch such that movement of the trigger may cause the catch to release, thereby allowing movement of the capture element toward the capture position. In other embodiments, a pest-capture device (e.g., 330) may include an electric trap, an adhesive mat, and/or the like.

In the second embodiment, pest-capture device 330 is configured to be coupled to base 310 via one or more fasteners 340 such as a screw, that may be disposed into or through body 331 of pest-capture device 330 and into or through base 310. However, in other embodiments, a pest-capture device (e.g., 330) may be coupled to other components of an apparatus (e.g., base 310, lid 320, and/or the like), and such coupling may be accomplished in any suitable fashion, such as, for example, via fastener(s), adhesive, interlocking features, and/or the like).

In the second embodiment of the present pest-management apparatuses for detecting pest capture, indicator 100 is configured to, when used with a container like apparatus 300, visually indicate to a user the state of pest-capture device 330 (e.g., set, actuated, and/or the like) disposed within chamber 321 when lid 320 is in the closed position. For example, in the embodiment shown, indicator 100 is configured to be coupled to pest-capture device 330 such that the indicator is movable in response to actuation of the pest-capture device, where movement of the indicator may be detected (e.g., by a user) from outside of chamber 321 without opening the device.

In the second embodiment, indicator 100 may be configured to, when in at least one position, extend outside of chamber 321, such as, for example, through an opening 350 defined by at least one of base 310 and lid 320. In the embodiment shown, indicator 100 may be flexible and resilient (e.g., spring-like) and may comprise a suitable (e.g., metal or plastic) material. In this embodiment, indicator 100 has a long dimension and a width and a thickness, each taken perpendicularly to the long dimension, where the width is larger than the thickness (e.g., at least 1.25, 1.50, 1.75, 2.00, 2.25, 2.50, 2.75, 3.00, 3.25, 3.50, 3.75, 4.00, 4.25, 4.50, 4.75, or 5.00 times the thickness), such that, for example, the indicator is less resistant to bending about one axis (e.g., an axis perpendicular to floor 311) than another axis (e.g., an axis parallel to a rotational axis of lid 320). In these ways and others, indicator 100 may be configured, through flexibility, to mitigate undesirable interference between the indicator and other components of apparatus 300 such as base 310 and/or lid 320 (e.g., during opening or closing of lid and during actuation of pest-capture device 330), while, through resilience, being able to extend upwardly from chamber 321 (and/or laterally outward from the chamber thereby enhancing visibility of the indicator. In the embodiment shown, indicator 100 includes a user-facing upper surface (e.g., extending along the long dimension thereof), at least a portion of which is visible (e.g., to a user) from outside chamber 321 during inspection of apparatus 300.

In the depicted embodiment, indicator 100 is configured to be coupled to pest-capture device 330 such that the indicator is movable between a first position and a second position in response to actuation of pest-capture device 330. More particularly, in the embodiment shown, indicator 100 is configured to be coupled to capture element 333 of pest-capture device 330, such that the indicator is movable between the first position and the second position in response to movement of the capture element between the set position and the capture position, respectively. In the embodiment shown, for example in FIG. 8, when indicator 100 is in the first position, the indicator extends above the upper surface of lid 320 and/or beyond an outermost edge of sidewall 313. In this embodiment, when indicator 100 is in the first position, the first body component 110 is visible from outside the chamber 321 and the distal end 122 of the second body component 120 extends above the lid 320 and latterly beyond the external perimeter of the base 310.

In the embodiment shown, the first body component 110, is at least partially visible (e.g., to a user) from outside of chamber 321 both when the indicator is in the first position and when the indicator is in the second position. In this embodiment, first body component 110 is at least partially visible (e.g., to a user) from outside of chamber 110 when indicator 100 is in the second position. However, in other embodiments of the present indicators and/or the present pest-management apparatuses for detecting pest capture, the indicator may not be visible from outside of a chamber (e.g., 321) when the indicator is in the second position. In these ways and others, via visual inspection of apparatus 300, a user may ascertain whether capture element 333 is in a set or actuated position, and thus whether pest-capture device 330 is set or has been actuated, respectively; an actuated pest-capture device directly indicates that (assuming normal operation and normal pest behavior) a pest has been captured.

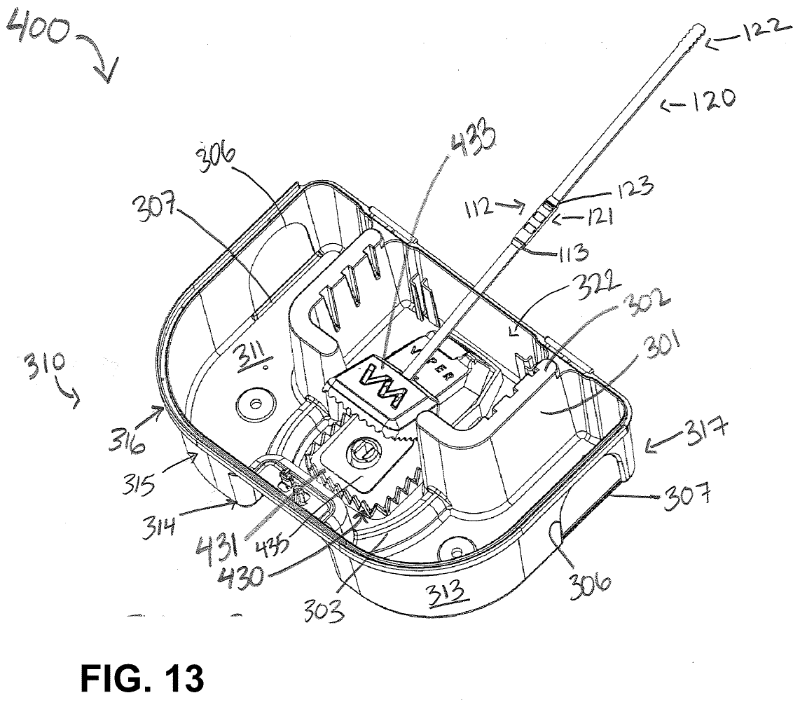

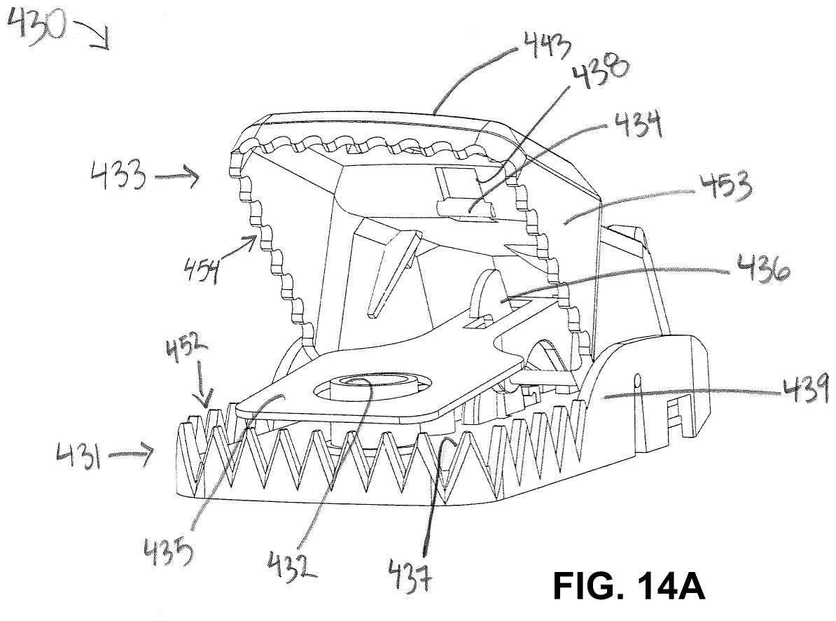

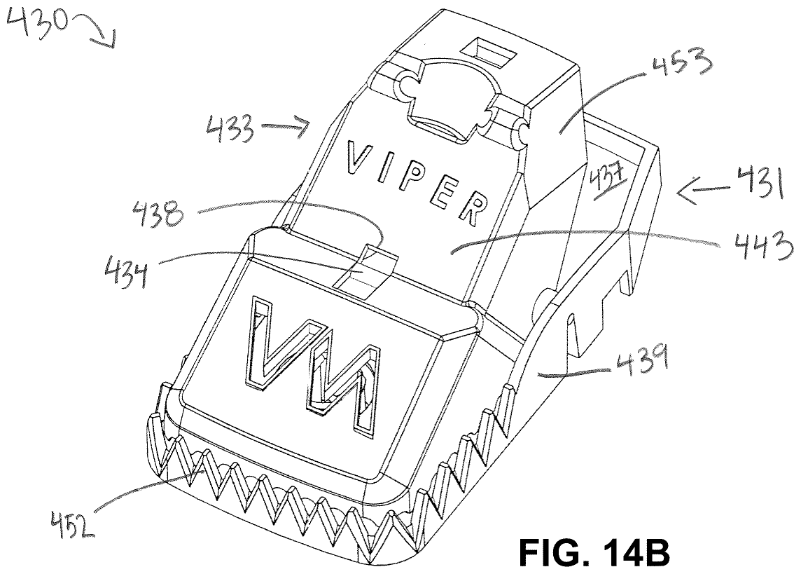

Referring to FIGS. 13-14B, shown is a pest management apparatus 400 that is substantially similar to apparatus 300, with the only exception being the configuration of pest capture device 430. Apparatus 400 includes pest capture device 430 disposable within chamber 321. In the third embodiment, pest-capture device 430 comprises a clamshell-style snap trap, having a lower jaw member 431, and an upper jaw member 433 that is movable relative to lower jaw member 431 between a set position and a capture position in which upper jaw member 433 is closer to lower jaw member 431 (e.g., as shown, for example, in FIGS. 14A and 14B) than it is in the capture position. In the embodiment shown, capture element 433 may be biased toward the capture position via a biasing member, such as, for example, a spring. In this embodiment, pest-capture device 430 includes a releasable catch 436 configured to retain capture element 433 in the set position and a trigger plate 435 coupled to the catch such that movement of trigger plate 435 may cause catch 436 to release, thereby allowing movement of the upper jaw member 433 toward the capture position. More particularly in this embodiment, pest capture device 430 has lower jaw member 431 having floor 437 defining opening 432 and sidewall 439 defines an external perimeter of lower jaw member 431 and has protruding teeth 452.

In the depicted embodiment, upper jaw member 433 has sidewall 453 defining an external perimeter of upper jaw member 433 and having protruding teeth 454 such that when pest capture device 430 is in the capture position teeth 454 are positioned inwardly of teeth 452. In other embodiments (not shown), teeth 454 may be positioned outwardly of or aligned with teeth 452. In the depicted embodiment, sidewall 453 extends around and descends from upper wall 443. In this embodiment, upper jaw member 433 is molded (e.g., injection molded). As such, upper wall 443 may be molded or machined to define an opening 438 (e.g., at the longitudinal center or within 20% of the overall length of the upper jaw member 433 from the longitudinal center) and a bar 434 extending across opening 438. In the depicted embodiments, bar 434 is spaced apart (i.e., proximally of) from the edge of the upper jaw member 433 that impacts a rodent when activated. Indicator 100 is configured to be coupled to pest-capture device 430 (e.g., via bar 434 across opening 438) such that the indicator is movable between a first position and a second position in response to actuation of pest-capture device 430. More particularly, in the embodiment shown, indicator 100 is configured to be coupled to bar 434 of upper jaw member 433 of pest-capture device 430, such that the indicator is movable between the first position and the second position in response to movement of upper jaw member 443 between the set position and the capture position, respectively. In other embodiments (not shown), bar 434 may be molded above upper wall 443 of upper jaw member 433 and/or opening 438 may be omitted, so long as indicator 100 can still be coupled to the bar.

In the depicted embodiment in which upper jaw member 433 is molded or otherwise formed in a three dimensional shape (rather than a bent wire), upper wall 443 spans a surface area (e.g., is equal to at least 30% of the surface area of floor 437 (e.g., 35%, 40%, 50%, 80%, 100%, 110%)).

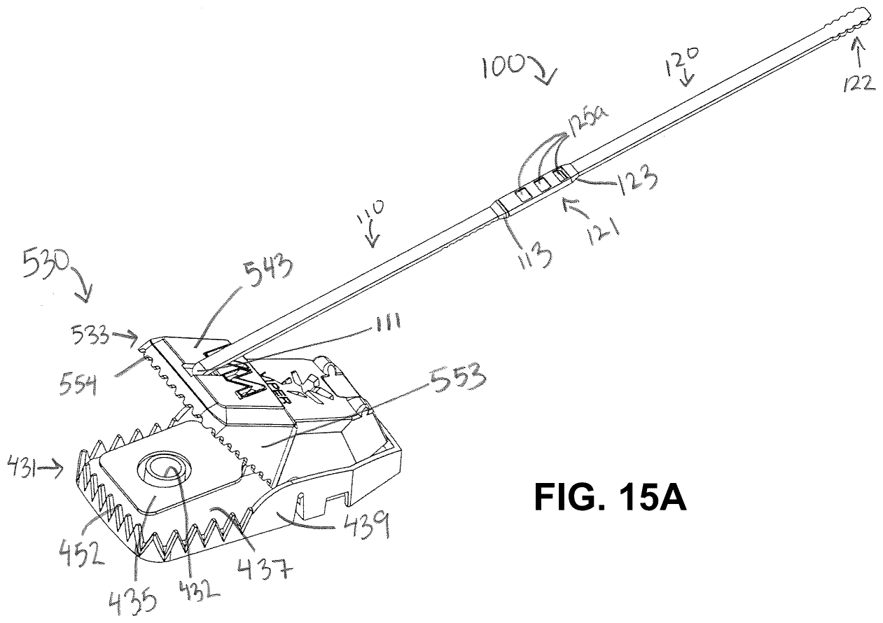

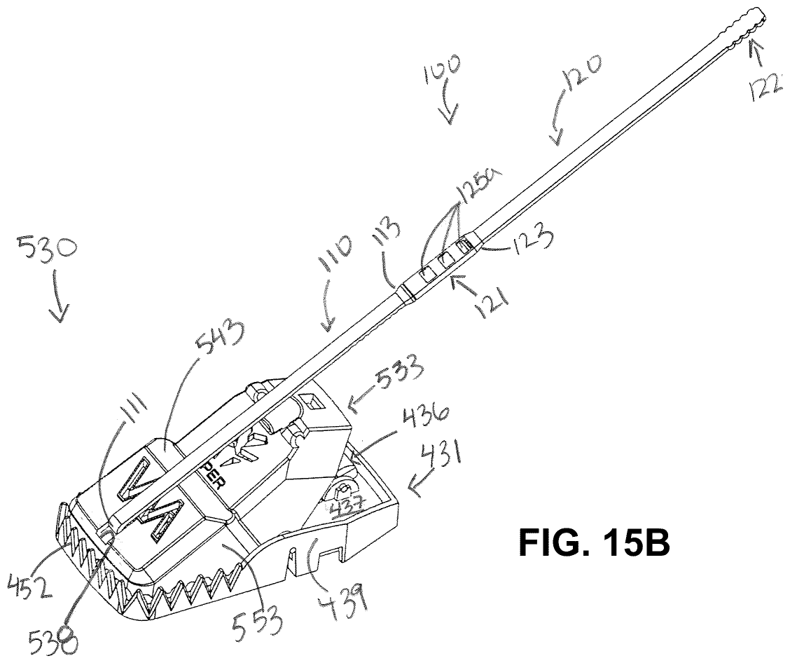

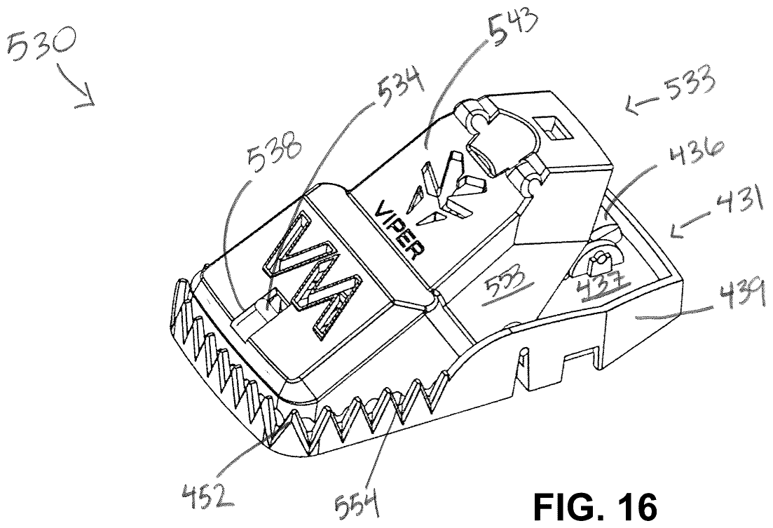

Referring to FIGS. 15A-16, shown is a pest capture device 530 that is substantially similar to device 430, the only exception being the configuration of upper wall 543. Pest capture device 530 includes lower jaw member 431 and upper jaw member 533 which is movable relative to lower jaw member 431 between a set position and a capture position in which upper jaw member 533 is closer to the lower jaw member 431. In this embodiment, upper jaw member 533 has sidewall 553 defining an external perimeter of upper jaw member 533 and having protruding teeth 554 such that when pest capture device 430 is in the capture position teeth 554 are positioned inwardly from teeth 452 of lower jaw member 431. In other embodiments (not shown), teeth 554 could be positioned outwardly from or aligned with teeth 452. In the depicted embodiment, upper jaw member 533 is molded having upper wall 543 defining opening 538 closer to a front edge of upper wall 543 and bar 534 extending across opening 538. More particularly, opening 438 can be disposed at the longitudinal front edge or, as shown, within 20% of the overall length of the upper jaw member 433 from the longitudinal front edge. In other embodiments (not shown), bar 534 could be molded above upper wall 543 of upper jaw member 533 without interrupting solid upper wall 543. In the depicted embodiments bar 534 is spaced apart from the edge of the upper jaw member 533 that impacts a rodent when activated. In the depicted embodiment, indicator 100 is configured to be coupled to pest-capture device 530 such that the indicator is movable between a first position and a second position in response to actuation of pest-capture device 530. More particularly, in the embodiment shown, indicator 100 is configured to be coupled to bar 534 of upper jaw member 533 of pest-capture device 530, such that the indicator is movable between the first position and the second position in response to movement of upper jaw member 543 between the set position and the capture position, respectively.

In the depicted embodiment in which upper jaw member 533 is molded or otherwise formed in a three dimensional shape (rather than a bent wire), upper wall 543 spans a surface area (e.g., is equal to at least 30% of the surface area of floor 437 (e.g., 35%, 40%, 50%, 80%, 100%, 110%)).

The surface of indicator 100 may be configured to visually indicate actuation of pest-capture device 330. In some embodiments, indicator 100 includes one or more colors or shapes which are visible (e.g., to a user) from outside of chamber 321 during inspection of pest-capture device 330. For example, first component 110 of indicator 100 may include a first color and/or first shape between proximal end 111 and first flared flange portion 113 and the second component 120 of indicator 100 may include a second color and/or second shape between second flared flanged portion 123 and distal 122, visually distinct from the first color and/or first shape. In some embodiments, first body component 110 of indicator 100 does not include the second color and/or second shape and/or the second body component 120 does not include the first color and/or first shape. More particularly, in some embodiments, the first body component 110 consists of the first color and/or first shape and/or the second body component 120 consists of the second color and/or second shape. The first color and/or first shape and the second color and/or second shape may be selected such that a user is able to visually distinguish between the first color and/or first shape and the second color and/or second shape (e.g., from a distance of at least 2, 3, 5, 10, or 15 feet away from apparatus 300).

When indicator 100 is in the first position, at least a portion of both the first and second colors/shapes on respective first and second body components 110 and 120 may be visible (e.g., to a user) from outside of chamber 321. After pest-capture device 330 is actuated, thereby moving indicator 100 to the second position, at least a majority of the first color and/or first shape of the first body component 110 that was visible in the first position is no longer visible (e.g., to the user) from outside of chamber 321. However, the second color and/or second shape of the second body component 120 remains at least partially visible (e.g., to the user) from outside of chamber 321 when indicator 100 is in the second position. In some embodiments, upon visual inspection of apparatus 300, the user may notice that only the second color and/or second shape of indicator 100 is visible, thereby indicating to the user that pest-capture device 330 has been actuated. In other embodiments of the present apparatuses for detecting pest capture, the indicator may be configured such that, upon visual inspection of a pest-management apparatus (e.g., 300), a user may notice that more of the second color and/or second shape is visible than the first color and/or first shape, thereby indicating to the user that pest-capture device 330 has been actuated; such a configuration may be achieved by adjusting the length of the first body component 110 such that at least some visible portion thereof will extend outside the relevant opening of the pest-management apparatus when the capture element of the pest-capture device to which it has been coupled is in the actuated position.

In some embodiments, at least a portion of an indicator (e.g., 100) is reflective. Alternatively, or additionally, at least a portion of an indicator (e.g., 100) includes one or more light emitting diodes (LEDs). For example, in such embodiments, the LEDs of the indicator (e.g., 100) may change in color, intensity, and/or blinking frequency (if applicable), in response to changing the indicator from a first state to a second state.

The above-described embodiments offer the benefits of streamlined, versatile, and customizable visual inspection of the state of pest-management apparatuses (e.g., between a set state and an actuated state). Furthermore, the above-described embodiments include the benefit of easily resetting the pest-management apparatus (e.g., from the actuated state to the set state) while the apparatus remains in a closed position. The described adaptable two-piece indicator offers a multifaceted solution to enhance trap monitoring and pest control efficiency. The interlocking connector provides a secure attachment to the kill bar of a snap trap, ensuring precise detection when the trap is triggered. The two-part construction enables the attachment of various indicators to the outer end of the strap. This feature allows for customization, as different color end pieces and shapes can be effortlessly connected to a portion of the indicator, providing clear visual cues for trap activity. Additionally, the option to attach such end pieces to a cable tie (e.g., one that has been preformed or configured manually by a user such that it can be coupled to the end piece) adds versatility to the system, making it a practical choice for a reliable and flexible solution to monitor snap trap activity within bait stations.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. An apparatus for detecting pest capture comprising:
an indicator having:
a first body component configured to be coupled to a capture element of a pest-capture device, the first body component having a proximal end and a connector end; and
a second body component configured to be coupled to the first body component, the second body component having a receptacle end and a distal end, the receptacle end configured to be coupled to the connector end of the first body component.

2. The apparatus of claim 1, wherein the proximal end of the first body component is configured to be removably coupled to the capture element of a pest-capture device.

3. The apparatus of claim 1, wherein a surface of the first body component includes a first color and a surface of the second body component includes a second color that is visually distinct from the first color.

4. The apparatus of claim 1, wherein the first body component includes a first shape and the second body component includes a second shape that is different from the first shape.

5. The apparatus of claim 1, wherein at least the first body component and/or the second body component of the indicator includes a reflective surface.

6. The apparatus of claim 1, wherein the first body component includes a first flared flange portion at a proximal portion of the connector end and the second body component includes a second flared flange portion at a distal portion of the receptacle end.

7. The apparatus of claim 1, wherein the second body component includes a receiving section at a proximal portion of the receptacle end and the receiving section is bordered by at least one rectangular-shaped opening positioned in a first wall of the proximal portion of the receptacle end and at least one rectangular-shaped opening positioned in a second wall of the proximal portion of the receptacle end, and wherein the receiving section is also bordered by a notch that begins at a proximal edge of the second wall of the proximal portion of the receptacle end.

8. The apparatus of claim 7, wherein a rectangular-shaped opening of the at least one rectangular-shaped opening positioned in the first wall is longitudinally offset from and oriented parallel to a rectangular-shaped opening of the at least one rectangular-shaped opening positioned in the second wall.

9. The apparatus of claim 7, wherein an inner surface of the first wall includes one or more first-wall teeth, and an inner surface of the second wall includes one or more second-wall teeth.

10. The apparatus of claim 9, wherein the inner surface of the first wall includes two sections of one or more first-wall teeth, the two sections separated from each other at least in part by a rectangular-shaped opening positioned in the first wall, and the inner surface of the second wall includes two sections of one or more second-wall teeth, the two sections separated from each other at least in part by a rectangular-shaped opening positioned in the second wall.

11. The apparatus of claim 1, wherein first and second sides of a distal portion of the connector end of the first body component each include at least one smooth section and at least one section having one or more connector-end teeth, and wherein the connector end and the receptacle end are configured such that the when the first body component is coupled to the second body component:
a smooth section of the at least one smooth section of the first side fits into a rectangularly-shaped opening of the at least one rectangularly-shaped opening positioned in the first wall;
a smooth section of the at least one smooth section of the second side fits into a rectangularly-shaped opening of the at least one rectangularly-shaped opening positioned in the second wall;
at least one of the one or more connector-end teeth of the first side interferes with one of the one or more first-wall teeth to resist separation of the first body component from the second body component in response to pulling the first and second body components in opposite directions; and
at least one of the one or more connector-end teeth of the second side interferes with one of the one or more second-wall teeth to resist separation of the first body component from the second body component in response to pulling the first and second body components in opposite directions.

12. The apparatus of claim 1, wherein the proximal end of the first body component comprises a first locking head and a strap portion extending from the first locking head, and the connector end of the first body component includes a distal portion of the strap portion and is configured to be inserted through an opening in the first locking head.

13. The apparatus of claim 12, wherein a first and/or a second side of the first body component includes one or more teeth and the receptacle end of the second body component comprises a second locking head, wherein the connector end and the receptacle end are configured such that the when the first body component is coupled to the second body component:
at least one of the one or more teeth of the first and/or second side of the first body component interferes with the second locking head of the receptacle end of the second body component to resist separation of the first body component from the second body component in response to pulling the first and second body components in opposite directions.

14. The apparatus of claim 1, further comprising:
a pest management apparatus having:
a base having a floor defining a first opening and a sidewall that defines an external perimeter of the base;
a lid coupled to the base such that the lid is movable relative to the base between an open position and a closed position in which the lid and the base cooperate to define a chamber;
a pest-capture device disposable within the chamber, the pest-capture device having a body defining a second opening and a capture element that is movable relative to the body between a set position and a capture position;
a fastener configured to extend through the first opening and the second opening to couple the pest-capture device to the base.

15. The apparatus of claim 14, wherein the apparatus is configured such that movement of the capture element from the capture position to the set position moves the indicator from a first position to a second position.

16. The apparatus of claim 15, wherein the proximal end of the first body component of the indicator is configured to be coupled to the capture element of the pest-capture device such that:
the indicator extends through and is movable relative to the pest management apparatus;
if the lid is in the closed position and the capture element is in the set position, the first body component of the indicator is visible from outside of the chamber and the distal end of the second body component of the indicator extends higher the lid and laterally beyond the external perimeter of the base; and
if the lid is in the closed position and the capture element is in the capture position, at least a majority of the first body component of the indicator is not visible from outside of the chamber; and
wherein the second end of the fastener is moveable between an engaged position and a released position.

17. The apparatus of claim 16, wherein, when the lid is in the closed position and the capture element is in the capture position, at least a majority of the second body component is visible from outside of the chamber.

18. A pest capture device comprising:
a lower jaw member having a floor defining an opening and a sidewall defining an external perimeter of the lower jaw member;
a capture element comprising an upper jaw member configured to be coupled to the lower jaw member such that the upper jaw member is movable relative to the lower jaw member between a set position and a capture position, the upper jaw member having an upper wall with a surface area which is greater than 30% of a surface area of the floor of the lower jaw member, the upper jaw member configured to be coupled to an indicator for detecting pest capture and/or a cable tie;
a trigger plate mounted to the lower jaw member such that the trigger plate is disposed between the lower jaw member and the upper jaw member; and
a catch mechanism which restrains the upper jaw member in the set position until the trigger plate is actuated.

19. The pest capture device of claim 18, wherein the upper wall of the upper jaw member defines an opening comprising a bar such that the bar is disposed within the opening.

20. The pest capture device of claim 19, wherein the indicator is coupled to the bar of the upper jaw member such that movement of the upper jaw member from the capture position to the set position moves the indicator from a first position to a second position.
